(19) United States
(12) Patent Application Publication
(10) Pub. No.: US 2007/0100065 A1
(43) Pub. Date: May 3, 2007

(54) SILICONE RUBBER COMPOSITION FOR SEALING STITCHED AIR BAG

(75) Inventors: Mitsuhiro IWATA, Takasaki-shi (JP); Yoshifumi HARADA, Takasaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Shin-Etsu Chemical Co., Ltd., Tokyo (JP)

(21) Appl. No.: 11/554,177

(22) Filed: Oct. 30, 2006

(30) Foreign Application Priority Data
Oct. 31, 2005 (JP) 2005-316252

(51) Int. Cl. C08L 83/04; B32B 27/00

(52) U.S. Cl. 524/588; 524/861; 524/862

(57) ABSTRACT

A silicone rubber composition for sealing a stitched air bag, wherein the composition exhibits excellent adhesion to cured silicone rubber. A silicone rubber composition for sealing a stitched air bag, in which the composition is used as a sealing material at those sections of a silicone rubber-treated base fabric that are superimposed with the treated surfaces facing each other and then stitched together to form a bag shape during formation of the air bag, and comprises: (A) an organopolysiloxane containing at least two alkenyl groups bonded to silicon atoms within each molecule, (B) a straight-chain organohydrogenpolysiloxane containing SiH groups only at the molecular chain terminals, (C) an organohydrogenpolysiloxane containing at least three SiH groups within each molecule, (D) a finely powdered silica, and (E) a platinum group metal-based catalyst, wherein the total quantity of all SiH groups within the components (B) and (C) is within a range from 0.01 to 20 groups per alkenyl group bonded to a silicon atom within the composition, and the number of SiH groups within the component (C) represents from 5 to 98 mol % of the total number of all SiH groups within the components (B) and (C).

### BACKGROUND OF THE INVENTION

1. Field of the Invention

The present invention relates to a silicone rubber composition that is used for sealing a stitched air bag.

2. Description of Related Art

Conventionally, the imparting of adhesiveness to an addition reaction-curable silicone rubber composition has generally involved the addition of γ-glycidoxypropyltrimethoxysilane, phenyltrimethoxysilane, or an adhesion assistant with the structure shown below (see patent reference 1).

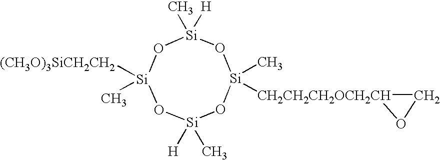

However, although these methods enable the generation of favorable adhesion to metals and plastics, the bonding of an uncured silicone rubber to an already cured silicone rubber has remained extremely difficult.

Silicone rubbers exhibit superior levels of water repellency, weather resistance and heat resistance, and are consequently widely used as coating agents and film-forming agents for all manner of substrates. However, silicone rubbers do not bond readily, and in order to improve their adhesion, silicone rubber adhesives comprising an organopolysiloxane that contains silicon atom-bonded alkenyl groups and either silicon atom-bonded alkoxy groups or silanol groups, a condensation reaction catalyst, and an organic peroxide have been proposed (see patent reference 2). Furthermore, a method has also been proposed in which silicone-coated sheets are overlaid, a platinum-based catalyst-containing addition reaction-curable silicone rubber adhesive or an organic peroxide-containing radical reaction-curable silicone rubber adhesive is disposed between the overlapped portions at room temperature, and the layered structure is then either pressure bonded and then heat cured, or subjected to heat curing while being held together under pressure (see patent reference 3). However, regardless of the adhesive or method described in any of the patent references employed, the resulting adhesion is not entirely satisfactory.

In addition, an addition reaction-curable silicone composition comprising a calcium carbonate powder has also been proposed as a potential silicone rubber adhesive (see patent reference 4). However, if the composition comprises an untreated heavy calcium carbonate powder, or a light (or precipitated) calcium carbonate powder that has only undergone surface treatment with a treatment agent such as a fatty acid, a resin acid or the like, then the calcium carbonate may act as a catalyst poison for the platinum group metal-based catalyst, causing a gradual retarding of the curing process over time, or even preventing curing entirely.

[Patent Reference 1]

U.S. Pat. No. 6,613,440

[Patent Reference 2]

EP 0207319 A2

[Patent Reference 3]

U.S. Pat. No. 4,889,576 or EP 0219075 A2

[Patent Reference 4]

US Pub. 2002/0129898 A1

### SUMMARY OF THE INVENTION

An object of the present invention is to provide a silicone rubber composition for sealing a stitched air bag, which is used as a sealing material at those sections of a silicone rubber-treated base fabric that are superimposed with the treated surfaces facing each other and then stitched together to form a bag shape during formation of the stitched air bag, and exhibits excellent adhesion to cured silicone rubber.

In order to achieve the object described above, the present invention provides a silicone rubber composition for sealing a stitched air bag, in which the composition is used as a sealing material at those sections of a silicone rubber-treated base fabric that are superimposed with the treated surfaces facing each other and then stitched together to form a bag shape during formation of the air bag, and comprises:
(A) 100 parts by mass of an organopolysiloxane containing at least two alkenyl groups bonded to silicon atoms within each molecule and having a viscosity at 23° C. within a range from 0.05 to 1,000 Pa·s,
(B) a straight-chain organohydrogenpolysiloxane containing hydrogen atoms bonded to silicon atoms only at the molecular chain terminals, in the form of siloxane units represented by the formula: R³₂HSiO_{1/2} (wherein, each R³ represents, independently, an unsubstituted or substituted monovalent hydrocarbon group that contains no aliphatic unsaturated bonds), and having a viscosity at 23° C. within a range from 0.001 to 100 Pa·s,
(C) an organohydrogenpolysiloxane containing at least three hydrogen atoms bonded to silicon atoms within each molecule, which contains siloxane units represented by R³HSiO and/or siloxane units represented by R³₂XSiO_{1/2} (wherein, each R³ represents, independently, an unsubstituted or substituted monovalent hydrocarbon group that contains no aliphatic unsaturated bonds, and X represents a hydrogen atom or an R³ group), and has a viscosity at 23° C. within a range from 0.001 to 100 Pa·s,
(D) from 1 to 100 parts by mass of a finely powdered silica with a specific surface area determined by a BET method of at least 50 m²/g, and
(E) an effective quantity of a platinum group metal-based catalyst, wherein

the total number of all hydrogen atoms bonded to silicon atoms within the component (B) and the component (C) is within a range from 0.01 to 20 per alkenyl group bonded to a silicon atom within the composition, and the number of hydrogen atoms bonded to silicon atoms within the component (C) represents from 5 to 98 mol % of the total number of all hydrogen atoms bonded to silicon atoms within the component (B) and the component (C).

The silicone rubber composition for sealing a stitched air bag according to the present invention can be used as a sealing material at those sections of a silicone rubber-treated base fabric that are superimposed with the treated surfaces facing each other and then stitched together to form a bag shape during formation of the stitched air bag, and exhibits excellent adhesion to cured silicone rubber.

### DETAILED DESCRIPTION OF THE INVENTION

As follows is a more detailed description of the present invention.

A silicone rubber composition for sealing a stitched air bag according to the present invention comprises the components (A) though (E) described below. This composition is used as a sealing material at those sections of a silicone rubber-treated base fabric that are superimposed with the treated surfaces facing each other and then stitched together to form a bag shape during formation of a stitched air bag. The silicone-treated base fabric is prepared by impregnating a base fabric with a silicone rubber, coating a base fabric with a silicone rubber, or a combination of both of these techniques. This treatment may be conducted only at the surface (or the surface layer) of the base fabric, or may be conducted so that the rubber penetrates into the interior of the fabric, and may be conducted on either one surface or both surfaces of the base fabric.

[(A) Organopolysiloxane]

The component (A) of a composition of the present invention is an organopolysiloxane containing at least two alkenyl groups bonded to silicon atoms within each molecule and having a viscosity at 23° C. within a range from 0.05 to 1,000 Pa·s, and functions as the principal component (the base polymer) of the composition of the present invention.

The viscosity at 23° C. of the organopolysiloxane of the component (A) is preferably within a range from 0.1 to 500 Pa·s. If the viscosity is less than 0.05 Pa·s, then the physical properties and adhesion of the cured product may be unsatisfactory, whereas if the viscosity exceeds 1,000 Pa·s, the fluidity of the composition may deteriorate markedly, which can lead to inferior workability.

The organopolysiloxane of the component (A) usually has a substantially straight-chain structure, and has preferably a straight-chain structure in which the principal chain comprises essentially repeating diorganosiloxane units and the molecular chain terminals are blocked with triorganosiloxy groups (in other words, a diorganopolysiloxane), although the structure may also include a partially branched structure. Furthermore, there are no particular restrictions on the bonding positions of the alkenyl groups, and they may be bonded to the silicon atoms at the molecular chain terminals, silicon atoms at non-terminal positions (within the molecular chain), or both these types of silicon atoms.

Examples of the organopolysiloxane of the component (A) include organopolysiloxanes represented by an average composition formula (1) shown below:
R¹ₘR²ₙSiO_{(4-m-n)/2} (1)
(wherein, each R¹ represents, independently, an unsubstituted or substituted monovalent hydrocarbon group that contains no aliphatic unsaturated bonds, each R² represents, independently, an alkenyl group, m is a number from 0.7 to 2.2, n is a number from 0.0001 to 0.2, and the sum m+n is a number within a range from 0.8 to 2.3), which also contain at least two alkenyl groups bonded to silicon atoms within each molecule.

In the above average composition formula (1), the unsubstituted or substituted monovalent hydrocarbon groups represented by R¹ are preferably groups of 1 to 10 carbon atoms, and suitable examples include alkyl groups such as methyl groups, ethyl groups, propyl groups, isopropyl groups, butyl groups, isobutyl groups, tert-butyl groups, hexyl groups, octyl groups, and decyl groups; aryl groups such as phenyl groups, tolyl groups, xylyl groups, and naphthyl groups; cycloalkyl groups such as cyclopentyl groups and cyclohexyl groups; aralkyl groups such as benzyl groups, 2-phenylethyl groups, and 3-phenylpropyl groups; and groups in which a portion of, or all of, the hydrogen atoms bonded to carbon atoms within these groups have been substituted with a halogen atom such as a chlorine atom, bromine atom or fluorine atom, or a cyano group, including chloromethyl groups, 2-bromoethyl groups, 3,3,3-trifluoropropyl groups, and cyanoethyl groups. Of these, methyl groups, phenyl groups, or a combination of these two groups are particularly preferred in terms of the ease of synthesis and the chemical stability of the organopolysiloxane. Furthermore, in those cases where an organopolysiloxane with particularly superior solvent resistance is required, combinations of methyl groups, phenyl groups, and trifluoropropyl groups are particularly desirable.

In the above average composition formula (1), the alkenyl groups represented by R² are preferably groups of 2 to 8 carbon atoms, and suitable examples include vinyl groups, allyl groups, 1-propenyl groups, isopropenyl groups, 1-butenyl groups, isobutenyl groups, and hexenyl groups. Of these, from the viewpoints of ease of synthesis and chemical stability, vinyl groups are preferred.

In the average composition formula (1), m is preferably within a range from 1.8 to 2.1, and even more preferably from 1.95 to 2.0, n is preferably within a range from 0.0005 to 0.1, and even more preferably from 0.01 to 0.05, and the sum of m+n is preferably within a range from 1.9 to 2.2, and even more preferably from 1.98 to 2.05.

Specific examples of this component (A) include copolymers of dimethylsiloxane and methylvinylsiloxane with both molecular chain terminals blocked with trimethylsiloxy groups, methylvinylpolysiloxane with both molecular chain terminals blocked with trimethylsiloxy groups, copolymers of dimethylsiloxane, methylvinylsiloxane, and methylphenylsiloxane with both molecular chain terminals blocked with trimethylsiloxy groups, copolymers of dimethylsiloxane, methylvinylsiloxane, and diphenylsiloxane with both molecular chain terminals blocked with trimethylsiloxy groups, dimethylpolysiloxane with both molecular chain terminals blocked with dimethylvinylsiloxy groups, methylvinylpolysiloxane with both molecular chain terminals blocked with dimethylvinylsiloxy groups, copolymers of dimethylsiloxane and methylvinylsiloxane with both molecular chain terminals blocked with dimethylvinylsiloxy groups, copolymers of dimethylsiloxane, methylvinylsiloxane, and methylphenylsiloxane with both molecular chain terminals blocked with dimethylvinylsiloxy groups, copolymers of dimethylsiloxane, methylvinylsiloxane, and diphenylsiloxane with both molecular chain terminals blocked with dimethylvinylsiloxy groups, dimethylpolysiloxane with both molecular chain terminals blocked with trivinylsiloxy groups, and dimethylpolysiloxane with both molecular chain terminals blocked with methyldivinylsiloxy groups.

The organopolysiloxane of the component (A) may use either a single material, or a combination of two or more different materials.

[(B) Straight-chain Organohydrogenpolysiloxane]

The component (B) of a composition of the present invention is a straight-chain organohydrogenpolysiloxane containing hydrogen atoms bonded to silicon atoms only at the molecular chain terminals, in the form of siloxane units represented by the formula: R³₂HSiO_{1/2} (wherein, each R³ represents, independently, an unsubstituted or substituted monovalent hydrocarbon group that contains no aliphatic unsaturated bonds), and having a viscosity at 23° C. within a range from 0.001 to 100 Pa·s, and preferably from 0.001 to 10 Pa·s. This component (B) functions as a curing agent. During curing, the component (B) increases the molecular chain length of the component (A), and also significantly affects the adhesion of the composition of the present invention to cured silicone rubbers.

Examples of the straight-chain organohydrogenpolysiloxane of the component (B) include compounds represented by a general formula (2) shown below.
R³₂HSiO(R³₂SiO)ₙSiR³₂H (2)
(wherein, each R³ represents, independently, an unsubstituted or substituted monovalent hydrocarbon group that contains no aliphatic unsaturated bonds, and n represents an integer that yields a viscosity at 23° C. of the organohydrogenpolysiloxane that falls within a range from 0.001 to 100 Pa·s and preferably from 0.001 to 10 Pa·s, and is typically an integer within a range from 2 to 1,000, and preferably from approximately 2 to 500)

In the above general formula, the unsubstituted or substituted monovalent hydrocarbon groups represented by R³ are preferably groups of 1 to 10, and even more preferably 1 to 8, carbon atoms, and specific examples of suitable groups include alkyl groups such as methyl groups, ethyl groups, propyl groups, butyl groups, pentyl groups, and hexyl groups; cycloalkyl groups such as cyclopentyl groups and cyclohexyl groups; aryl groups such as phenyl groups, tolyl groups, xylyl groups, and naphthyl groups; aralkyl groups such as benzyl groups, and phenethyl groups; and halogen-substituted groups such as 3,3,3-trifluoropropyl groups and 3-chloropropyl groups.

Specific examples of this component (B) include dimethylpolysiloxane with both molecular chain terminals blocked with dimethylhydrogensiloxy groups, dimethylpolysiloxane with both molecular chain terminals blocked with diphenylhydrogensiloxy groups, methylphenylpolysiloxane with both molecular chain terminals blocked with dimethylhydrogensiloxy groups, diphenylpolysiloxane with both molecular chain terminals blocked with dimethylhydrogensiloxy groups, copolymers of dimethylsiloxane and methylphenylsiloxane with both molecular chain terminals blocked with dimethylhydrogensiloxy groups, and copolymers of dimethylsiloxane and diphenylsiloxane with both molecular chain terminals blocked with dimethylhydrogensiloxy groups.

The straight-chain organohydrogenpolysiloxane of the component (B) may use either a single material, or a combination of two or more different materials.

[(C) Organohydrogenpolysiloxane]

The component (C) of a composition of the present invention is an organohydrogenpolysiloxane containing at least three hydrogen atoms bonded to silicon atoms within each molecule, which contains siloxane units represented by R³HSiO and/or siloxane units represented by R³₂XSiO_{1/2} (wherein, each R³ represents, independently, an unsubstituted or substituted monovalent hydrocarbon group that contains no aliphatic unsaturated bonds, and X represents a hydrogen atom or an R³ group), and has a viscosity at 23° C. within a range from 0.001 to 100 Pa·s, and preferably from 0.001 to 10 Pa·s. This component (C) also functions as a curing agent. Furthermore, the number of silicon atoms within each molecule (the polymerization degree) is typically within a range approximately from 2 to 1,000, preferably approximately from 2 to 500, even more preferably approximately from 2 to 300, and is most preferably from approximately 2 to 100, whereas the number of hydrogen atoms bonded to silicon atoms (namely, SiH groups) within each molecule is typically within a range from 3 to 1,000, preferably from 3 to 500, even more preferably from 3 to 300, and is most preferably from approximately 3 to 100. The component (C) is essential in ensuring that the cured product is formed as a three dimensionally cross-linked rubber, and the component also significantly affects the adhesion of the composition of the present invention to cured silicone rubbers. There are no particular restrictions on the molecular structure of the organohydrogenpolysiloxane of the component (C), and suitable structures include straight-chain, cyclic, branched-chain, and three dimensional network structures, although straight-chain, cyclic, or branched-chain structures are usually preferred.

Examples of the unsubstituted or substituted monovalent hydrocarbon groups represented by R³ in the above formulas include the same types of groups as those described above in relation to the component (B), and specific examples include the same groups as those listed above in the section relating to the component (B).

The hydrogen atoms boned to silicon atoms (namely, SiH groups) within the molecules of the organohydrogenpolysiloxane of the component (C) may exist at both the molecular chain terminals and non-terminal positions within the molecular chain (that is, molecular side chains), or may exist at only the molecular chain terminals or only non-terminal positions within the molecular chain.

Examples of the organohydrogenpolysiloxane of the component (C) include the compounds represented by the general formulas shown below. 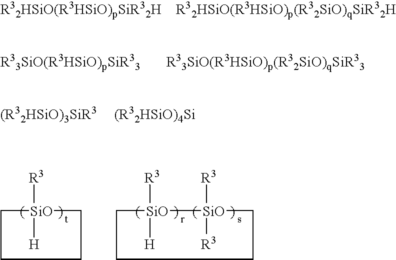
(wherein, R³ is as defined above, p, q, r and s each represent, independently, an integer of 1 or greater, t represents an integer from 4 to 20, r+s represents an integer from 4 to 20, and p and p+q represent integers that yield a viscosity at 23° C. of the organohydrogenpolysiloxane that falls within a range from 0.001 to 100 Pa·s and preferably from 0.001 to 10 Pa·s, and typically represent integers within a range from 2 to 1,000, preferably from 2 to 500, even more preferably from 2 to 300, and most preferably from 2 to 100)

Specific examples of the organohydrogenpolysiloxane of the component (C) include tris(hydrogendimethylsiloxy)methylsilane, tris(hydrogendimethylsiloxy)phenylsilane, 1,3,5,7-tetramethylcyclotetrasiloxane, methylhydrogencyclopolysiloxane, cyclic copolymers of methylhydrogensiloxane and dimethylsiloxane, methylhydrogenpolysiloxane with both terminals blocked with trimethylsiloxy groups, copolymers of dimethylsiloxane and methylhydrogensiloxane with both terminals blocked with trimethylsiloxy groups, methylhydrogenpolysiloxane with both terminals blocked with dimethylhydrogensiloxy groups, copolymers of dimethylsiloxane and methylhydrogensiloxane with both terminals blocked with dimethylhydrogensiloxy groups, copolymers of methylhydrogensiloxane and diphenylsiloxane with both terminals blocked with trimethylsiloxy groups, copolymers of methylhydrogensiloxane, diphenylsiloxane and dimethylsiloxane with both terminals blocked with trimethylsiloxy groups, copolymers of methylhydrogensiloxane, methylphenylsiloxane and dimethylsiloxane with both terminals blocked with trimethylsiloxy groups, copolymers of methylhydrogensiloxane, dimethylsiloxane and diphenylsiloxane with both terminals blocked with dimethylhydrogensiloxy groups, copolymers of methylhydrogensiloxane, dimethylsiloxane and methylphenylsiloxane with both terminals blocked with dimethylhydrogensiloxy groups, copolymers comprising (CH₃)₂HSiO_{1/2} units, (CH₃)₃SiO_{1/2} units, and SiO_{4/2} units, copolymers comprising (CH₃)₂HSiO_{1/2} units and SiO_{4/2} units, and copolymers comprising (CH₃)₂HSiO_{1/2} units, SiO_{4/2} units, and (C₆H₅)₃SiO_{1/2} units, as well as compound which a portion of the methyl groups in the above compounds have been substituted, either with other alkyl groups such as ethyl groups or propyl groups, or with aryl groups such as phenyl groups.

The organohydrogenpolysiloxane of the component (C) may use either a single material, or a combination of two or more different materials.

In this composition, the combined total number of all the hydrogen atoms bonded to silicon atoms (namely, SiH groups) within the component (B) and the component (C) relative to each alkenyl group bonded to a silicon atom within the composition (usually only the alkenyl groups bonded to silicon atoms within the organopolysiloxane of the component (A), but in those cases where other components that contain silicon atom-bonded alkenyl groups, such as the component (H) described below, are included within the composition, the combined total number of all alkenyl groups bonded to silicon atoms within all of the components of the composition) must fall within a range from 0.01 to 20, and is preferably from 0.1 to 10. If this total number of SiH groups yields a ratio of less than 0.01, then the composition tends to suffer from unsatisfactory curing, whereas if the ratio exceeds 20, then the mechanical properties and heat resistance of the cured product tend to deteriorate.

Furthermore, the number of hydrogen atoms bonded to silicon atoms within the component (C) must represent from 5 to 98 mol%, and preferably represents from 10 to 95 mol%, of the combined total number of all hydrogen atoms bonded to silicon atoms within the component (B) and the component (C). If this proportion of hydrogen atoms is less than 5 mol%, then the composition tends to suffer from unsatisfactory curing, whereas if the proportion exceeds 98 mol%, then the elongation properties of the cured product tend to deteriorate, leading to a deterioration in the heat resistance.

Accordingly, the blend quantities of the component (B) and the component (C) must be determined so that the respective quantities of SiH groups within the components (B) and (C) satisfy the ranges defined above.

[(D) Finely Powdered Silica]

The component (D) of a composition of the present invention is a finely powdered silica with a specific surface area determined by a BET method of at least 50 m²/g, and is added to the composition to improve the strength of the cured product. The BET specific surface area is measured using a nitrogen gas adsorption method (BET method), and is typically within a range from 50 to 400 m²/g, and preferably from 100 to 350 m²/g. The finely powdered silica of the component (D) may be either a hydrophilic silica or a hydrophobic silica. Specific examples of suitable silica materials include wet silicas such as precipitated silica, hydrophilic silica that has not undergone surface treatment, including dry silicas such as silica xerogel and fumed silica, and hydrophobic silicas that have been converted to a hydrophobic form through surface treatment of one of the above hydrophilic silica materials with an organosilicon compound such as a halogenated silane, alkoxysilane, organosilazane, or organosiloxane.

In those cases where a hydrophilic finely powdered silica is used, the surface of the silica is preferably subjected to hydrophobic treatment with a hydrophobic treatment agent prior to use if required. Examples of these hydrophobic treatment agents include organosilazanes such as hexamethyldisilazane; halogenated silanes such as methyltrichlorosilane, dimethyldichlorosilane, and trimethylchlorosilane; and organoalkoxysilanes in which the halogen atoms in the halogenated silanes have been substituted with an alkoxy group such as a methoxy group or ethoxy group. Of these treatment agents, hexamethyldisilazane is preferred. One example of a suitable method for conducting this hydrophobic treatment involves heating the hydrophilic finely powdered silica and the hydrophobic treatment agent at a temperature of 150 to 200° C., and preferably from 150 to 180° C., for a period of 2 to 4 hours. In those cases where the hydrophobic treatment is conducted, the finely powdered silica may be subjected to hydrophobic treatment in advance, and the treated silica then added to the composition of the present invention, or alternatively, a combination of the hydrophilic finely powdered silica and the hydrophobic treatment agent may be added as the component (D) during preparation of the composition of the present invention.

Examples of suitable commercially available hydrophobic silicas include products such as Aerosil R-812, R-812S, R-972, and R-974 (manufactured by Degussa AG), Rheorosil MT-10 (manufactured by Tokuyama Corporation), and the Nipsil SS series or products (manufactured by Nippon Silica Industry Co., Ltd.). Examples of commercially available hydrophilic silicas include products such as Aerosil 50, 130, 200, and 300 (manufactured by Nippon Aerosil Co., Ltd.), Cabosil MS-5 and MS-7 (manufactured by Cabot Corporation), Rheorosil QS-102 and 103 (manufactured by Tokuyama Corporation), and Nipsil LP (manufactured by Nippon Silica Industry Co., Ltd.).

The blend quantity of the component (D) must fall within a range from 1 to 100 parts by mass per 100 parts by mass of the component (A), and is preferably within a range from 1.1 to 50 parts by mass. If the blend quantity is less than 1 part by mass, then the strengthening effect may be insufficient, whereas if the quantity exceeds 100 parts by mass, then the fluidity of the composition may deteriorate markedly, and the workability of the composition may also deteriorate. The finely powdered silica of the component (D) may use either a single material, or a combination of two or more different materials.

[(E) Platinum Group Metal-based Catalyst]

The component (E) of a composition of the present invention is a platinum group metal-based catalyst, and can use any of the materials conventionally used as hydrosilylation reaction catalysts. Examples of suitable materials include platinum group simple metals such as platinum black, rhodium and palladium; platinum chlorides, chloroplatinic acids and chloroplatinates such as H₂PtCl₄.nH₂O, H₂PtCl₆.nH₂O, NaHPtCl₆.nH₂O, KHPtCl₆.nH₂O, Na₂PtCl₆.nH₂O, K₂PtCl₄.nH₂O, PtCl₄.nH₂O, PtCl₂ and Na₂HPtCl₄.nH₂O (wherein, n represents an integer from 0 to 6, and preferably either 0 or 6);; alcohol modified chloroplatinic acids (see U.S. Pat. No. 3,220,972); complexes of a chloroplatinic acid and an olefin (see U.S. Pat. Nos. 3,159,601, 3,159,662 and 3,775,452); a platinum group metal such as platinum black or palladium supported on a carrier such as alumina, silica or carbon; rhodium-olefin complexes; chlorotris(triphenylphosphine)rhodium (Wilkinson's catalyst); and complexes of a platinum chloride, chloroplatinic acid or chloroplatinate with a vinyl group-containing siloxane, and particularly with a vinyl group-containing cyclic siloxane. Of these, platinum-based catalysts such as chloroplatinic acids, platinum-olefin complexes, platinum-vinylsiloxane complexes, platinum black, and platinum-triphenylphosphine complexes are preferred.

There are no particular restrictions on the blend quantity of the component (E), which needs only be sufficient to ensure the desired curing rate, although a typical quantity, calculated as a mass-referenced quantity of the platinum group metal, is within a range from 0.1 to 1,000 ppm, and preferably from 0.1 to 500 ppm, and even more preferably from 0.5 to 200 ppm, relative to the total mass of the composition of the present invention. The platinum group metal-based catalyst of the component (E) may use either a single material, or a combination of two or more different materials.

[Other components]

In addition to the components (A) through (E) described above, components (F), (G) and (H) described below, and any other optional components, may also be added to the composition, provided such addition does not impair the effects of the present invention.

(F) Titanium Chelate, Alkoxytitanium

A titanium chelate and/or alkoxytitanium compound may also be added to a composition of the present invention as a component (F). By including this component (F), the adhesion of the composition can be further improved. Specific examples of suitable titanium chelates include diisopropoxybis(acetylacetonato)titanium, diisopropoxybis(ethyl acetoacetonato)titanium, and dibutoxybis(methyl acetoacetonato)titanium. Specific examples of suitable alkoxytitanium compounds include tetraethyl titanate, tetrapropyl titanate, and tetrabutyl titanate. The alkoxy portion of the alkoxytitanium compound may be either a straight-chain or branched.

In those cases where the component (F) is added to a composition of the present invention, the blend quantity is preferably within a range from 0.01 to 10 parts by mass, and preferably from 0.01 to 5 parts by mass, per 100 parts by mass of the component (A). Provided the blend quantity satisfies this range, an excellent level of adhesion is obtained, and the surface curability of the composition is also favorable. The titanium chelate and/or alkoxytitanium of the component (F) may use either a single material, or a combination of two or more different materials.

(G) Inorganic Fillers other than the Component (D)

Inorganic fillers other than the aforementioned component (D) may also be added to a composition of the present invention as a component (G). Examples of suitable fillers include colorants, including inorganic pigments such as cobalt blue as well as organic dyes and the like; and heat resistance and flame retardancy improvers such as diatomaceous earth, potassium oxide, zinc oxide, iron oxides, titanium oxides, aluminum oxide, copper oxides, calcium carbonate, zinc carbonate, manganese carbonate, red iron oxide, carbon black, crushed quartz powder, aluminum hydroxide, copper, silver, gold, and nickel. Furthermore, the surfaces of these inorganic fillers may be subjected to treatment with an organosilicon compound such as an organoalkoxysilane, organohalosilane, or organosilazane.

In those cases where the component (G) is added to a composition of the present invention, the blend quantity is typically no greater than 100 parts by mass (namely, more than 0 parts by mass, but no more than 100 parts by mass), and is preferably within a range from 0.1 to 100 parts by mass, and even more preferably from 1 to 50 parts by mass, per 100 parts by mass of the component (A). Provided the blend quantity satisfies this range, the mechanical properties such as the strength and elongation, and the heat resistance and the like, of the silicone rubber cured product can be improved. The inorganic filler of the component (G) may use either a single material, or a combination of two or more different materials.

(H) Organopolysiloxane Resin with a Three Dimensional Network Structure

An organopolysiloxane resin with a three dimensional network structure may also be added to a composition of the present invention as a component (H). Organopolysiloxane resins that contain alkenyl groups bonded to silicon atoms within the molecular structure are preferred as the component (H) as they generate increased strength for the cured product.

In those cases where the component (H) contains alkenyl groups bonded to silicon atoms, the quantity of these alkenyl groups is preferably within a range from 1 to 5% by mass, and preferably from 2 to 3% by mass, of all the organic groups bonded to silicon atoms within the component (H). Provided the alkenyl group content satisfies this range, the strength, elongation and heat resistance properties of the cured product can be improved.

Suitable examples of the component (H) include organopolysiloxane resins comprising monofunctional siloxane units represented by the formula R⁴₃SiO_{1/2} (wherein, R⁴ represents an unsubstituted or substituted monovalent hydrocarbon group that contains no aliphatic unsaturated bonds) such as (CH₃)₃SiO_{1/2}, and siloxane units represented by the formula SiO_{4/2}; and organopolysiloxane resins that include, within each molecule, siloxane units that contain an alkenyl group bonded to a silicon atom, together with siloxane units represented by the formula SiO_{4/2} or siloxane units represented by the formula R⁴SiO_{3/2} (wherein, R⁴ is as defined above) or both of these types of units; and the latter of the above two types of resins is preferred. In some cases, this latter organopolysiloxane resin may also include monofunctional siloxane units represented by the formula R⁴₃SiO_{1/2} within each molecule.

Examples of the above siloxane units that contain an alkenyl group bonded to a silicon atom include siloxane units represented by the formula R^{A}SiO_{3/2}, siloxane units represented by the formula R^{A}R^{B}SiO_{2/2}, and siloxane units represented by the formula R^{A}^{B}₂SiO_{1/2} (where in each formula, R^{A} represents an alkenyl group, and each R^{B} represents, independently, an unsubstituted or substituted monovalent hydrocarbon group).

The above group R⁴ is preferably a monovalent hydrocarbon group of 1 to 10 carbon atoms, and suitable examples include the same types of groups as those described above for the group R¹ within the average composition formula (1). Specific examples of suitable groups include the same groups as those listed above for the group R¹ within the average composition formula (1), although a methyl group and phenyl group are particularly desirable.

The group R^{A} is preferably an alkenyl group of 2 to 8 carbon atoms, and suitable examples include the same types of groups as those described above for the group R² within the average composition formula (1). Specific examples of suitable groups include the same groups as those listed above for the group R² within the average composition formula (1), although a vinyl group is particularly preferred.

The group R^{B} is preferably a monovalent hydrocarbon group of 1 to 10 carbon atoms, and suitable examples include the same types of groups as those described above for the group R¹ within the average composition formula (1), or an alkenyl group. Specific examples of suitable groups include the same groups as those listed above for the group R¹ within the average composition formula (1), as well as alkenyl groups such as an allyl group or vinyl group, although monovalent hydrocarbon groups that contain no aliphatic unsaturated bonds are preferred, and a methyl group or phenyl group is particularly desirable.

The aforementioned organopolysiloxane resin that includes alkenyl groups bonded to silicon atoms within each molecule preferably contains alkenyl groups such as vinyl groups, and organopolysiloxane resins that include, within each molecule, siloxane units that contain an alkenyl group (namely, R^{C}SiO_{3/2} units, R^{C}R^{D}SiO_{2/2} units or R^{C}R^{D}₂SiO_{1/2} units (where in each formula, R^{C} represents an alkenyl group of 2 to 8 carbon atoms, and each R^{D} represents, independently, an unsubstituted or substituted monovalent hydrocarbon group of 1 to 10 carbon atoms)), SiO_{4/2} units, and/or R^{E}SiO_{3/2} units (wherein R^{E} represents an unsubstituted or substituted monovalent hydrocarbon group of 1 to 10 carbon atoms that contains no aliphatic unsaturated bonds) are particularly desirable. Specific examples of organopolysiloxane resins that contain no alkenyl groups bonded to silicon atoms include resins comprising (CH₃)₃SiO_{1/2} units and SiO_{4/2} units, whereas specific examples of organopolysiloxane resins that contain alkenyl groups bonded to silicon atoms include resins comprising (CH₃)₃SiO_{1/2} units, (CH₂═CH)SiO_{3/2} units and SiO_{4/2} units, resins comprising (CH₂═CH)(CH₃)₂SiO_{1/2} units, and SiO_{4/2} units, resins comprising (CH₂═CH)(CH₃)₂SiO_{1/2} units, (CH₂═CH)SiO_{3/2} units, and SiO_{4/2} units, and resins comprising (CH₂=CH)(CH₃)₂SiO_{1/2} units, (CH₃)₃SiO_{1/2} and SiO_{4/2} units.

Suitable examples of the group R^{C} include the same types of groups as those described above for the group R² within the average composition formula (1). Specific examples of suitable groups include the same groups as those listed above for the group R² within the average composition formula (1), although a vinyl group is particularly preferred.

Suitable examples of the group R^{D} include the same types of groups as those described above for the group R¹ within the average composition formula (1), or an alkenyl group, and preferred groups include alkyl groups, aryl groups or alkenyl groups. Specific examples of suitable groups include the same groups as those listed above for the group R¹ within the average composition formula (1), as well as alkenyl groups such as an allyl group or vinyl group, although a methyl group or phenyl group is particularly desirable.

Suitable examples of the group R^{E} include the same types of groups as those described above for the group R¹ within the average composition formula (1), and alkyl groups or aryl groups are particularly preferred. Specific examples of suitable groups include the same groups as those listed above for the group R¹ within the average composition formula (1), although a methyl group or phenyl group is particularly desirable.

In those cases where the component (H) is added to a composition of the present invention, the blend quantity is typically no greater than 100 parts by mass (namely, more than 0 parts by mass, but no more than 100 parts by mass), and is preferably within a range from 0.1 to 100 parts by mass, and even more preferably from 1 to 50 parts by mass, per 100 parts by mass of the component (A). The organopolysiloxane with a three dimensional network structure of the component (H) may use either a single material, or a combination of two or more different materials.

Other Components

A composition of the present invention may also include curing retarders, adhesion-imparting agents and the like.

Examples of suitable curing retarders, which are used for improving the storage stability of the composition of the present invention, or improving the handling and workability of the composition by adjusting the curing time or pot life of the composition, include acetylene-based compounds such as 3-methyl-1-butyn-3-ol, 3,5-dimethyl-1-hexyn-3-ol, and 3-phenyl-1-butyn-3-ol; ene-yne compounds such as 3-methyl-3-penten-1-yne and 3,5-dimethyl-3-hexen-1-yne; organopolysiloxane compounds that contain 5% by mass or greater of vinyl groups within each molecule, such as 1,3-divinyl-1,1,3,3-tetramethyldisiloxane, 1,3-divinyl-1,1,3,3-tetraphenyldisiloxane, 1,3,5,7-tetramethyl-1,3,5,7-tetravinylcyclotetrasiloxane, 1,3,5,7-tetramethyl-1,3,5,7-tetrahexenylcyclotetrasiloxane, methylvinylpolysiloxane with both molecular chain terminals blocked with silanol groups, and copolymers of methylvinylsiloxane and dimethylsiloxane with both molecular chain terminals blocked with silanol groups; triazoles such as benzotriazole; as well as phosphines, mercaptans and hydrazines, and these curing retarders may be used either alone, or as a combination of two or more different compounds.

In those cases where a curing retarder is added to a composition of the present invention, the blend quantity is typically within a range from 0.001 to 5 parts by mass, and preferably from 0.01 to 5 parts by mass, per 100 parts by mass of the component (A).

Examples of suitable adhesion-imparting agents, which are added to improve the adhesion, include silane coupling agents such as methyltrimethoxysilane, vinyltrimethoxysilane, allyltrimethoxysilane, 3-methacryloxypropyltrimethoxysilane, 3-glycidoxypropyltrimethoxysilane, 3-aminopropyltrimethoxysilane, N-(2-aminoethyl)-3-aminopropyltrimethoxysilane, bis(trimethoxysilyl)propane, and bis(trimethoxysilyl)hexane; titanium compounds such as titanium ethylacetonate and titanium acetylacetonate; aluminum compounds such as ethylacetoacetate aluminum diisopropylate, aluminum tris(ethylacetoacetate), alkylacetoacetate aluminum diisopropylate, aluminum tris(acetylacetonate), and aluminum monoacetylacetonate bis(ethylacetoacetate); and zirconium compounds such as zirconium acetylacetonate, zirconium butoxyacetylacetonate, zirconium bis(acetylacetonate), and zirconium ethylacetoacetate, and these adhesion-imparting agents may be used either alone, or as a combination of two or more different compounds.

In those cases where an adhesion-imparting agent is added, there are no particular restrictions on the blend quantity, although a quantity within a range from 0.01 to 10 parts by mass per 100 parts by mass of the component (A) is preferred.

[Method of Preparation]

There are no particular restrictions on the method used for preparing the composition of the present invention, and the components (A) through (E) can be simply mixed together, together with any other optional components that are added as required. Furthermore, the composition may also be prepared by first mixing together the component (A) and the component (D) under heat to form a base compound, and then adding the component (B), the component (C) and the component (E) to this base compound. During the preparation of the base compound, the surface of the component (D) may be subjected to in-situ treatment by addition of an aforementioned organosilicon compound (namely, hydrophobic surface treatment). In those cases where other components also need to be added, these other components may also be added during preparation of the base compound. However, if any of the other compounds are likely to undergo degeneration during mixing under heat, then these compounds may be added at the same time as the addition of the components (B), (C) and (E). During preparation of the composition of the present invention, a conventional mixing device such as a two roll mill, three roll mill, kneader-mixer or planetary mixer may be used.

In the same manner as most typical curable silicone rubber compositions, a composition of the present invention may be prepared as a so-called two-pot composition, where two liquids are prepared separately, and these two liquids are then mixed together and cured at the time of use.

The curing conditions employed for a composition of the present invention may be similar to those used for conventional addition reaction-curable silicone rubber compositions, and although most compositions will cure adequately at room temperature and generate a cured product with favorable adhesion, if necessary, curing may also be conducted by heating at a temperature within a range approximately from 40 to 180° C.

### EXAMPLES

As follows is a more detailed description of the present invention based on a series of examples. In the following examples, Me represents a methyl group, and viscosity values refer to values measured at 23° C.

### Example 1

100 parts by mass of a dimethylpolysiloxane with both molecular chain terminals blocked with dimethylvinylsiloxy groups and having a viscosity of 30 Pa·s, 15 parts by mass of a fumed silica with a BET specific surface area of 300 m²/g, 1.5 parts by mass of hexamethyldisilazane as a surface treatment agent for the silica, and 1 part by mass of water were mixed together uniformly, and were then mixed further under reduced pressure while heating at a temperature of 160° C. for 4 hours, thus yielding a base compound. Subsequently, to 115 parts by mass of this base compound were added and mixed a component (B) comprising a dimethylpolysiloxane with both molecular chain terminals blocked with dimethylhydrogensiloxy groups and with a viscosity of 0.01 Pa·s (in such a quantity that makes the molar ratio of silicon atom-bonded hydrogen atoms within this component, relative to the vinyl groups bonded to silicon atoms within the dimethylpolysiloxane with both molecular chain terminals blocked with dimethylvinylsiloxy groups contained within the base compound, 0.1), a component (C) comprising (Me₂HSiO)₃SiMe containing three silicon atom-bonded hydrogen atoms within each molecule and with a viscosity of 0.0012 Pa·s (in such a quantity that makes the molar ratio of silicon atom-bonded hydrogen atoms within this component, relative to the vinyl groups bonded to silicon atoms within the dimethylpolysiloxane with both molecular chain terminals blocked with dimethylvinylsiloxy groups contained within the base compound, 1.4), 0.2 part by mass of a copolymer of dimethylsiloxane and methylvinylsiloxane with both molecular chain terminals blocked with silanol groups and with a viscosity of 40 mPa·s as a curing retarder (the vinyl group content within this component=8% by mass), 0.3 part by mass of tetrabutyl titanate, and a 1,3-divinyltetramethyldisiloxane complex of platinum (in such a quantity to provide a mass of platinum metal within this catalyst of 25 parts by mass for every 1,000,000 parts by mass of the dimethylpolysiloxane within the base compound), thereby completing preparation of a composition. The molar ratio of the combined total quantity of all silicon atom-bonded hydrogen atoms within the component (B) and the component (C) relative to the quantity of all the vinyl groups bonded to silicon atoms within the composition was 1.5.

This composition was subjected to the tests described below. The results of the tests are shown in Table 1.

Hardness

The composition was cured by leaving to stand for one day at 23° C. The hardness of the resulting cured product was then measured using a type A durometer as prescribed in JIS K6253.

Tensile Strength and Elongation

The composition was cured by leaving to stand for one day at 23° C,. and a dumbbell-shaped No. 3 test piece was prepared in accordance with JIS K6251. The tensile strength and elongation of this dumbbell-shaped No. 3 test piece were then measured using the method prescribed in JIS K6251.

Adhesive Strength to Cured Silicone Rubber

The adhesive strength of the composition to a cured silicone rubber was measured in the following manner, using the method prescribed in JIS K6854. Namely, the composition was applied to a silicone rubber-coated nylon base fabric of width 25 mm in sufficient quantity to form a film of thickness 0.6 mm, the composition-coated portions of the fabric were stuck together, and the composition was then cured by leaving to stand for one day at 23° C. Subsequently, using this bonded base fabric, a T-peel test was conducted at a pull speed of 200 mm/minute. The result of the test is shown in Table 1.

Fracture Mode (State of Fracture following Peeling)

Following completion of the T-peel test, the fracture mode was determined by visually inspecting the state of the interface between the cured product and the silicone rubber-coated nylon fabric. In those cases where the cured product of the present invention was deemed to have undergone cohesive failure, the result was recorded in Table 1 as “cohesive fracture”, whereas in those cases where fracture occurred within the silicone rubber of the silicone rubber-coated nylon fabric, the result was recorded in Table 1 as “silicone rubber fracture”.

Storage Stability

In order to test the storage stability, a mixture was prepared in the same manner as the example 1 but excluding the curing agent components (namely, the component (B) and the component (C)). This mixture was left to stand for one week at 70° C., and the above curing agent components were then added to the mixture to complete preparation of the composition. This composition was then cured to form a cured product. Using the methods described above, the physical properties of this cured product (namely, the hardness, elongation, tensile strength, and adhesive strength (note, subsequent references to physical properties refer to this list of properties)) were measured, and the fracture mode was determined.

Determinations were made as to whether or not curing had been retarded in the composition that had been left to stand relative to the composition prior to standing, whether or not there was any deterioration in the physical properties of the cured product after the composition was left to stand, and whether or not there were any changes in the fracture mode between the composition prior to standing and the composition that had been left to stand. Specifically, if the curing time of the composition that had been left to stand was two or more times longer than the curing time of the composition prior to standing, then the curing was deemed to have been retarded by standing. In the case of the various physical properties, if the measured value of (a physical property of) the cured product following standing was 70% or smaller than that for the cured product of the composition prior to standing, then that property was deemed to have deteriorated by standing. If no curing retardation occurred, none of the above physical properties had deteriorated, and the fracture mode had not changed, then the storage stability was evaluated as favorable, and was recorded in Table 1 using the symbol “A”, whereas in all other cases the storage stability was evaluated as unsatisfactory.

### Example 2

Using the same procedure as the example 1, but with the exceptions of altering the quantity of the dimethylpolysiloxane with both molecular chain terminals blocked with dimethylhydrogensiloxy groups and with a viscosity of 0.01 Pa·s to a quantity that represents a molar ratio of 0.7 between the silicon atom-bonded hydrogen atoms within this component and the vinyl groups bonded to silicon atoms within the dimethylpolysiloxane with both molecular chain terminals blocked with dimethylvinylsiloxy groups contained within the base compound, and altering the quantity of (Me₂HSiO)₃SiMe containing three silicon atom-bonded hydrogen atoms within each molecule and with a viscosity of 0.0012 Pa·s to a quantity that represents a molar ratio of 0.8 between the silicon atom-bonded hydrogen atoms within this component and the vinyl groups bonded to silicon atoms within the dimethylpolysiloxane with both molecular chain terminals blocked with dimethylvinylsiloxy groups contained within the base compound, a composition was prepared in the same manner as the example 1, and the physical properties of the cured product, the storage stability of the composition, and the fracture mode were determined in the same manner as the example 1. The results are shown in Table 1. In this composition, the molar ratio of the combined total quantity of all silicon atom-bonded hydrogen atoms within the component (B) and the component (C) relative to the quantity of all the vinyl groups bonded to silicon atoms within the composition was 1.5.

### Example 3

Using the same procedure as the example 1, but with the exceptions of altering the quantity of the dimethylpolysiloxane with both molecular chain terminals blocked with dimethylhydrogensiloxy groups and with a viscosity of 0.01 Pa·s to a quantity that represents a molar ratio of 1.2 between the silicon atom-bonded hydrogen atoms within this component and the vinyl groups bonded to silicon atoms within the dimethylpolysiloxane with both molecular chain terminals blocked with dimethylvinylsiloxy groups contained within the base compound, and altering the quantity of (Me₂HSiO)₃SiMe containing three silicon atom-bonded hydrogen atoms within each molecule and with a viscosity of 0.0012 Pa·s to a quantity that represents a molar ratio of 0.3 between the silicon atom-bonded hydrogen atoms within this component and the vinyl groups bonded to silicon atoms within the dimethylpolysiloxane with both molecular chain terminals blocked with dimethylvinylsiloxy groups contained within the base compound, a composition was prepared in the same manner as the example 1, and the physical properties of the cured product, the storage stability of the composition, and the fracture mode were determined in the same manner as the example 1. The results are shown in Table 1. In this composition, the molar ratio of the combined total quantity of all silicon atom-bonded hydrogen atoms within the component (B) and the component (C) relative to the quantity of all the vinyl groups bonded to silicon atoms within the composition was 1.5.

### Comparative Example 1

Using the same procedure as the example 1, but with the exceptions of not adding the dimethylpolysiloxane with both molecular chain terminals blocked with dimethylhydrogensiloxy groups and with a viscosity of 0.01 Pa·s, and altering the quantity of the (Me₂HSiO)₃SiMe containing three silicon atom-bonded hydrogen atoms within each molecule and with a viscosity of 0.0012 Pa·s to a quantity that represents a molar ratio of 1.5 between the silicon atom-bonded hydrogen atoms within this component and the vinyl groups bonded to silicon atoms within the dimethylpolysiloxane with both molecular chain terminals blocked with dimethylvinylsiloxy groups contained within the base compound, a composition was prepared in the same manner as the example 1, and the physical properties of the cured product, the storage stability of the composition, and the fracture mode were determined in the same manner as the example 1. The results are shown in Table 1. In this composition, the molar ratio of the quantity of the silicon atom-bonded hydrogen atoms within the component (C) relative to the quantity of all the vinyl groups bonded to silicon atoms within the composition was 1.5.

### Comparative Example 2

Using the same procedure as the example 1, but with the exceptions of altering the quantity of the dimethylpolysiloxane with both molecular chain terminals blocked with dimethylhydrogensiloxy groups and with a viscosity of 0.01 Pa·s to a quantity that represents a molar ratio of 1.5 between the silicon atom-bonded hydrogen atoms within this component and the vinyl groups bonded to silicon atoms within the dimethylpolysiloxane with both molecular chain terminals blocked with dimethylvinylsiloxy groups contained within the base compound, and not adding the (Me₂HSiO)₃SiMe containing three silicon atom-bonded hydrogen atoms within each molecule and with a viscosity of 0.0012 Pa·s, a composition was prepared in the same manner as the example 1, and the physical properties of the cured product, the storage stability of the composition, and the fracture mode were determined in the same manner as the example 1. The results are shown in Table 1. In this composition, the molar ratio of the quantity of the silicon atom-bonded hydrogen atoms within the component (B) relative to the quantity of all the vinyl groups bonded to silicon atoms within the composition was 1.5.

TABLE 1

| | | | | Comparative | Comparative |
|---|---|---|---|---|---|
| | Example 1 | Example 2 | Example 3 | example 1 | example 2 |
| Hardness | 12 | 9 | 5 | 22 | * Did not cure |
| Elongation (%) | 1600 | 1760 | 1960 | 970 | |
| Tensile strength (MPa) | 4.1 | 4.2 | 2.5 | 5.3 | |
| Adhesive strength (kgf/25 mm) | 6.2 | 5.6 | 5.1 | 7.1 | |
| Fracture mode | Cohesive | Cohesive | Cohesive | Silicone rubber | |
| | fracture | fracture | fracture | fracture | |
| Storage stability | A | A | A | A | |

* Because the composition prepared in the comparative example 2 did not cure, the physical properties, the fracture mode, and the storage stability could not be determined.

What is claimed is:

1. A silicone rubber composition for sealing a stitched air bag, in which said composition is used as a sealing material at those sections of a silicone rubber-treated base fabric that are superimposed with treated surfaces facing each other and then stitched together to form a bag shape during formation of said air bag, and comprises:
(A) 100 parts by mass of an organopolysiloxane containing at least two alkenyl groups bonded to silicon atoms within each molecule and having a viscosity at 23° C. within a range from 0.05 to 1,000 Pa·s,
(B) a straight-chain organohydrogenpolysiloxane containing hydrogen atoms bonded to silicon atoms only at molecular chain terminals, in a form of siloxane units represented by a formula: R³₂HSiO_{1/2} (wherein, each R³ represents, independently, an unsubstituted or substituted monovalent hydrocarbon group that contains no aliphatic unsaturated bonds), and having a viscosity at 23° C. within a range from 0.001 to 100 Pa·s,
(C) an organohydrogenpolysiloxane containing at least three hydrogen atoms bonded to silicon atoms within each molecule, which contains siloxane units represented by R³HSiO and/or siloxane units represented by R³₂XSiO_{1/2} (wherein, each R³ represents, independently, an unsubstituted or substituted monovalent hydrocarbon group that contains no aliphatic unsaturated bonds, and X represents a hydrogen atom or an R³ group), and has a viscosity at 23° C. within a range from 0.001 to 100 Pa·s,
(D) from 1 to 100 parts by mass of a finely powdered silica with a specific surface area determined by a BET method of at least 50 m²/g, and
(E) an effective quantity of a platinum group metal-based catalyst, wherein
a total number of all hydrogen atoms bonded to silicon atoms within said component (B) and said component (C) is within a range from 0.01 to 20 per alkenyl group bonded to a silicon atom within said composition, and a number of hydrogen atoms bonded to silicon atoms within said component (C) represents from 5 to 98 mol % of a total number of all hydrogen atoms bonded to silicon atoms within said component (B) and said component (C).

2. The composition according to claim 1, further comprising a titanium chelate and/or alkoxytitanium compound as a component (F), in a quantity within a range from 0.01 to 10 parts by mass per 100 parts by mass of said component (A).

3. The composition according to claim 1, further comprising an inorganic filler different from said component (D) as a component (G), in a quantity exceeding 0 parts by mass but no more than 100 parts by mass per 100 parts by mass of said component (A).

4. The composition according to claim 2, further comprising an inorganic filler different from said component (D) as a component (G), in a quantity exceeding 0 parts by mass but no more than 100 parts by mass per 100 parts by mass of said component (A).

5. The composition according to claim 1, further comprising an organopolysiloxane resin with a three dimensional network structure as a component (H), in a quantity exceeding 0 parts by mass but no more than 100 parts by mass per 100 parts by mass of said component (A).

6. The composition according to claim 2, further comprising an organopolysiloxane resin with a three dimensional network structure as a component (H), in a quantity exceeding 0 parts by mass but no more than 100 parts by mass per 100 parts by mass of said component (A).

7. The composition according to claim 3, further comprising an organopolysiloxane resin with a three dimensional network structure as a component (H), in a quantity exceeding 0 parts by mass but no more than 100 parts by mass per 100 parts by mass of said component (A).

8. A composition according to claim 5, wherein said component (H) is an organopolysiloxane resin comprising, within each molecule, siloxane units that contain an alkenyl group bonded to a silicon atom, together with siloxane units represented by a formula SiO_{4/2} and/or siloxane units represented by a formula R⁴SiO_{3/2} (wherein, R⁴ represents an unsubstituted or substituted monovalent hydrocarbon group that contains no aliphatic unsaturated bonds).
